(19) United States
(12) Patent Application Publication
(10) Pub. No.: US 2002/0082986 A1
(43) Pub. Date: Jun. 27, 2002

(54) Method for payment in exchange

(76) Inventor: Hsi-Peng Lu, Taipei (TW)

Correspondence Address: JACOBSON HOLMAN PLLC, 400 SEVENTH STREET N.W., SUITE 600, WASHINGTON, DC, 20004, US

(21) Appl. No.: 09/746,478

(22) Filed: Dec. 26, 2000

(51) Int. Cl. G06F 17/60

(52) U.S. Cl. 705/39

(57) ABSTRACT

A payment method in transaction has the steps of customer providing a customer code issued by the transaction identification center to the merchant for undergoing a transaction by the mobile communication device; merchant presenting an invoicing request to the transaction identification center by means of the mobile communication device and inputting a merchant code issued by the transaction identification center, the customer code and consumed money to the transaction identification center; transaction identification center presenting a payment request to the customer with the merchant name and the consumed money for consent; the customer inputting the transaction code to show the consent of this transaction or pressing a predetermined button for cancellation; the transaction identification center confirming the input transaction code and generating an authorization code to the merchant to show the recognition of this transaction; and recording the transaction information in a financial organization for sending this information regularly to the customer.

### BACKGROUND OF THE INVENTION

1. Field of the Invention

The present invention relates to a method for payment, and more particularly to a mobile payment method in which a payment mechanism is established among a client, a merchant and a transaction identification center so that a card-free concept is used to complete the exchange by means of wireless transmission.

2. Prior Art Description

Normally a credit card is most popularly used in payment while exchange. However, when the cardholder is using the credit card to pay for the goods purchased, the cardholder worries that the credit card might be copied while shopped in a real shop or the credit card number might be hacked in the INTERNET transmission while shopped in the virtual shop. The shop also concerns that the credit card or the signature on the received credit card might be a forged one.

In order to better under the exchange pattern while using a credit card, referring to FIG. 1, which shows the flow chart concerning the interrelationships among the cardholder, the merchant and the bank or the like. The flow chart comprises the steps of:

A. cardholder using a credit card to purchase in a merchant;

B. the merchant inputting the credit card number into a credit card authorization terminal (POS);

C. the POS connecting with the bank, thus showing the code for the POS at the bank end and in return the merchant code;

D. the merchant inputting the consuming price into the POS;

E. the bank or the like confirming received data and sending a confirmation signal back to the merchant;

F. the POS printing out the receipt; and

G. the cardholder signing the receipt.

In the pattern as described above while using the credit card as the exchange media, the credit inspection and confirmation by the bank is completed entirely by the input data of the credit card number from the merchant end. No direct contact between the bank and the cardholder, which lacks reliability.

While shopping in a real merchant, the merchant may copy the credit card number when the cardholder is watching elsewhere so as that the merchant may undergo illegitimate business. While shopping with an e-merchant, since there is no handwriting “signature” in the INTERNET, the e-merchant may encounter the risk of not only a fraudulent credit card number but also the customer's denial of order placed.

For safe electronic payment, the National Computer Security Association (NCSA) has identified four essential security requirements:

1. Authentication: the message sender is who they claim to be.

2. Privacy (Encryption): the contents of message are secret and only known to the sender and the receiver.

3. Integrity: the contents of message are not accidentally or maliciously altered or destroyed during transmission.

4. Non-repudiation: the sender of message cannot deny that they actually send the message.

To ensure the safety of INTERNET shopping, the VISA and the MasterCard organizations jointly developed the “Secure Electronic Transaction; SET” and published on Feb. 23, 1996. Other related safety systems are also developed and introduced into the market, such as the “Secure Transaction Technology; STT”, “Secure Electronic Payments Protocol; SEPP”, “Internet Keyed Payment; IKP” and “Net Trust and Cybercash Credit Payment Protocol”.

To fulfill the four essential security requirement, SET protocol includes four identities: cardholder, merchant, CA (certification authority), and payment gateway. Each entity needs its own certificate. However, the SET protocol is complex and certificates (or the public key infrastructure, PKI) are not widely distributed in a stable manner, especially in the cardholder side. As a result, we need an equally secure but more convenient payment method in both physical shopping and INTERNET shopping.

Besides, if the credit card was lost or stolen and the cardholder did not report the loss to the authorization immediately, should there be one using the lost or stolen credit card, the bank would not be able to find out whether this credit card is an illegitimate one and will still issue a authorization code to the merchant to complete the exchange, which increases the risk of loss in exchange. According to the research by the VISA CARD, every $100 US dollars spent by using the credit card, about 8 cent will be lost in deceptive transaction. Although, this is not a large amount of money, however, since the total transaction volume is up to $700 million USD from the year of 1998 in electronic transaction, which results that the total loss through electronic transaction would be a great deal of money and this loss will be added to the customer and the shop eventually.

Apparently, using credit card to complete a transaction in the real word or through INTERNET still has to encounter the risk of not only a fraudulent credit card number but also the customer's denial of order placed. Handwriting signature may easily be imitated in real world and be insubstantial in the INTERNET. The certificates and digital signature are too complex to be accepted by most cardholders. Therefore, the present invention provides an improved payment method to obviate and mitigate the above shortcomings.

### SUMMARY OF THE INVENTION

To overcome the above shortcomings, the primary objective of the invention is to provide a mobile communication payment system to undertake a cross check system to double confirm the identity of the customer before the exchange is completed. So neither the customer nor the bank will bear the burden of losing money in transaction. The system is established a payment mechanism among customers (with a registered communication device, customer code, and transaction code), merchants (with a registered merchant code), a transaction identification center (with the correlated table of customer code, transaction code, customer's call number of communication device, and another correlated table of merchant code and other merchant information), and payment gateways (of financial organizations). The transaction identification center (or financial or other authority organization) issues a customer code and a transaction code to a registered customer, and a merchant code to a registered merchant.

Another objective of the invention is to provide an improved payment method by using two different sets of codes to complete the transaction. One set of the codes is provided to the customer by the transaction identification center to undergo a transaction and the other is provided to the merchant also by the transaction identification center to complete the transaction. With these two different sets of codes, the customer's and the merchant's rights are secured.

Other objects, advantages and novel features of the invention will become more apparent from the following detailed description when taken in conjunction with the accompanying drawings.

### BRIEF DESCRIPTION OF THE DRAWINGS

FIG. 1 is a schematic view showing the relationships among the customer, the merchant and bank or the credit card center when a transaction is undergone;

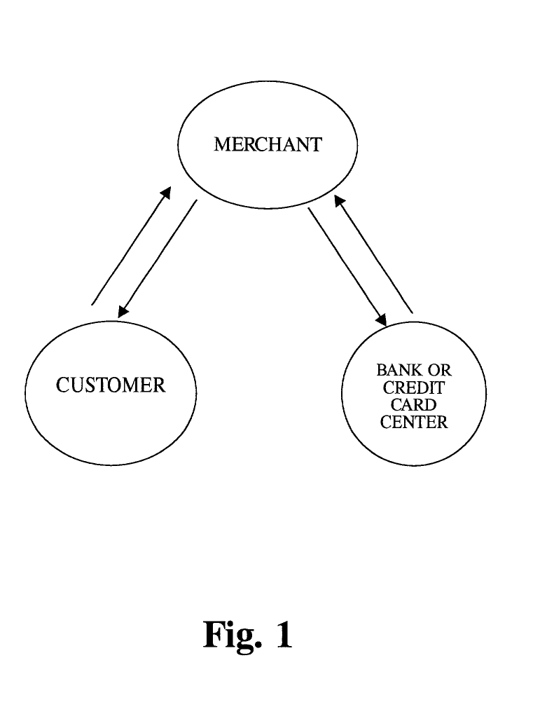

FIG. 2 is a framework of the method in accordance with the present invention;

FIG. 3 is a flow chart showing the steps of the method;

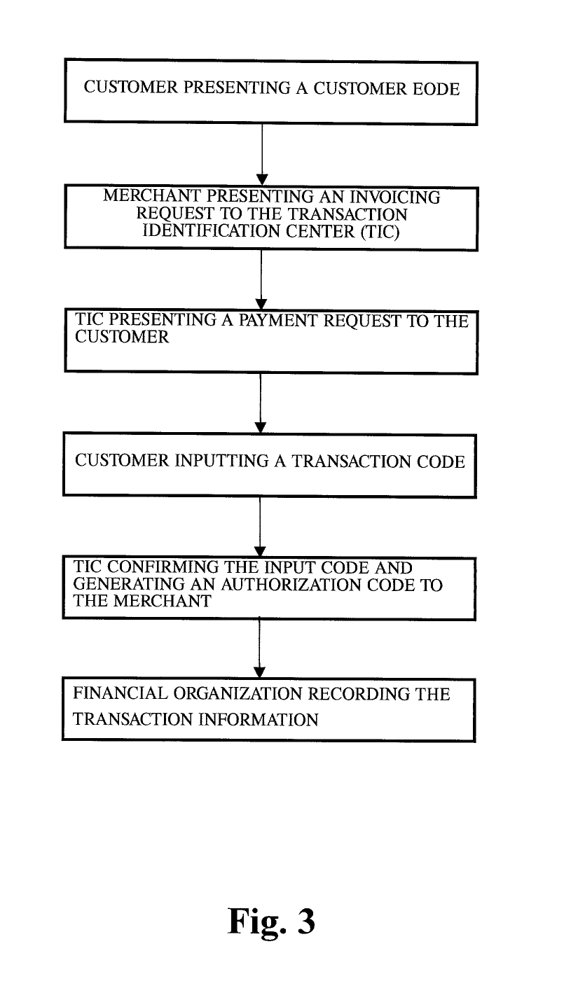

FIG. 4 is a schematic view showing the payment mechanism in the transaction identification center; and

FIG. 5 is a schematic view showing the relationships among the customer, the merchant and the transaction identification center when the method of the invention is implemented.

### DETAILED DESCRIPTION TO THE PREFERRED EMBODIMENT

Before the detailed description of the invention, a number of terms should be explained first to clarify the meaning when used.

Customer: one who has mobile communication devices, such as a cellular phone, person digital assistance (PDA) and being assigned a customer code by an transaction identification center or a authorization organization and a transaction code showing the agreement to undertake the mobile payment system by the transaction identification center;

Real merchants: general shops who have applied to use the mobile payment system of the invention;

Virtual merchants: shops who have registered in the INTERNET and have applied to use the mobile payment system of the invention;

Merchants: the real merchants and the virtual merchants;

Transaction identification center: a service center that provides the invoicing request to the merchants, confirmation to the customer and manages the customers' codes;

Financial organization: a payment gateway to execute accounting record and perform all the accounting related businesses;

Authorization code: a code authorized to the merchants by the transaction identification center to show that the transaction has been recognized;

Invoicing request: a request presented by the merchants to the transaction identification center; and

Payment request: a request presented by the transaction identification center to the customer to confirm whether the transaction is valid.

Because mobile communication devices are mostly popular all over the world, the payment system of the present invention is thus based on the mobile communication devices to establish a payment mechanism among the customer, the merchants and the transaction identification center. With the mobile communication devices, the transaction identification center is able to confirm the customer's identity in real time and then store all the transaction information in the financial organization.

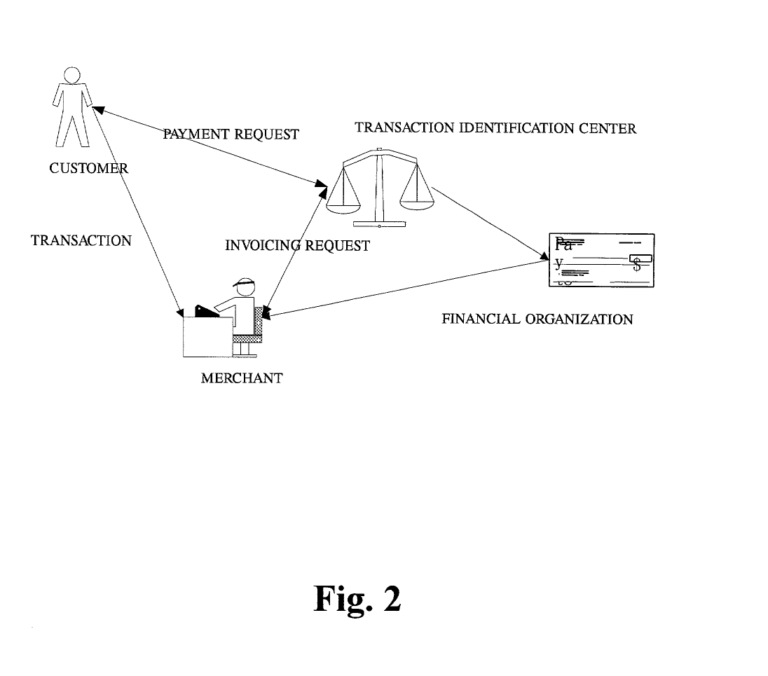

The primary framework of the invention is as shown in FIG. 2, wherein the necessary facilities are:

1. Customer: provided with mobile communication devices, such as a mobile phone, a PDA etc.;

2. Merchants: provided with a computer, a telecommunication device or any suitable communication devices that is able to connect with the transaction identification center;

3. Transaction identification center: provided with data bank to restore all the transaction information, related interface program, voice system and Website for processing invoicing request.

The payment method in exchange in accordance with the present invention has the steps of:

Customer providing a customer code issued by the transaction identification center to the merchant for undergoing a transaction;

Merchant presenting an invoicing request to the transaction identification center by means of suitable communication devices, such as a telephone, a mobile phone or even a computer capable of connecting with the INTERNET and inputting a merchant code issued by the transaction identification center, the customer code and consumed money to the transaction identification center.

Transaction identification center presenting a payment request to the customer with the merchant name and the consumed money for consent

The customer inputting the transaction code to show the consent of this transaction or pressing a predetermined button for cancellation;

The transaction identification center confirming the input transaction code and generating an authorization code to the merchant to show the recognition of this transaction; and

The financial organization recording the transaction information for sending this information regularly to the customer.

With the customer code and the transaction code, the identity of the customer can be double checked for confirmation. Thus, the rights of the customer and the transaction identification center are secured.

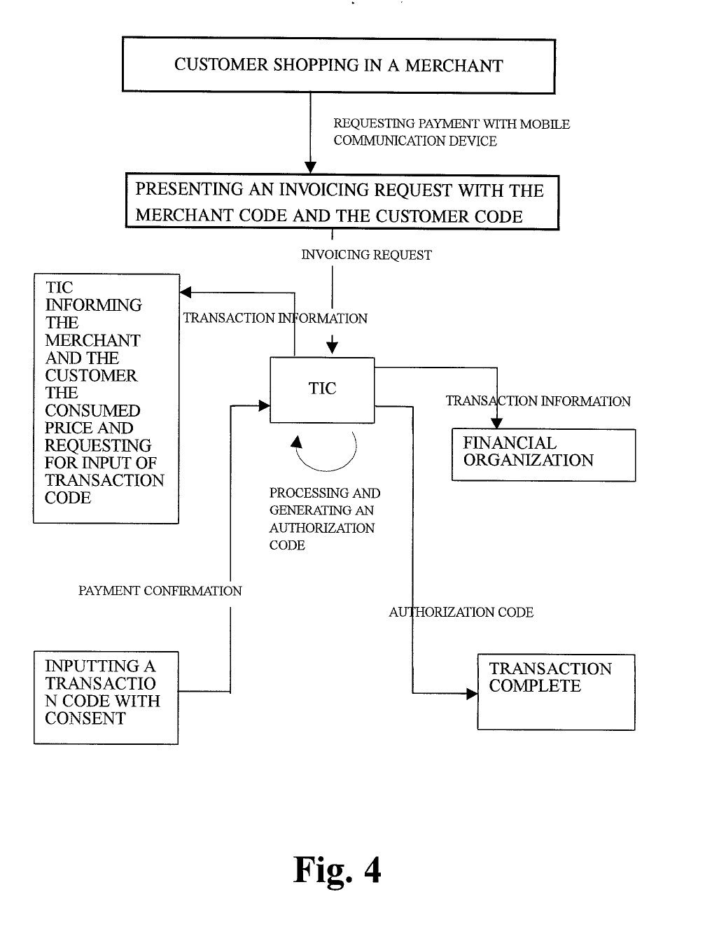

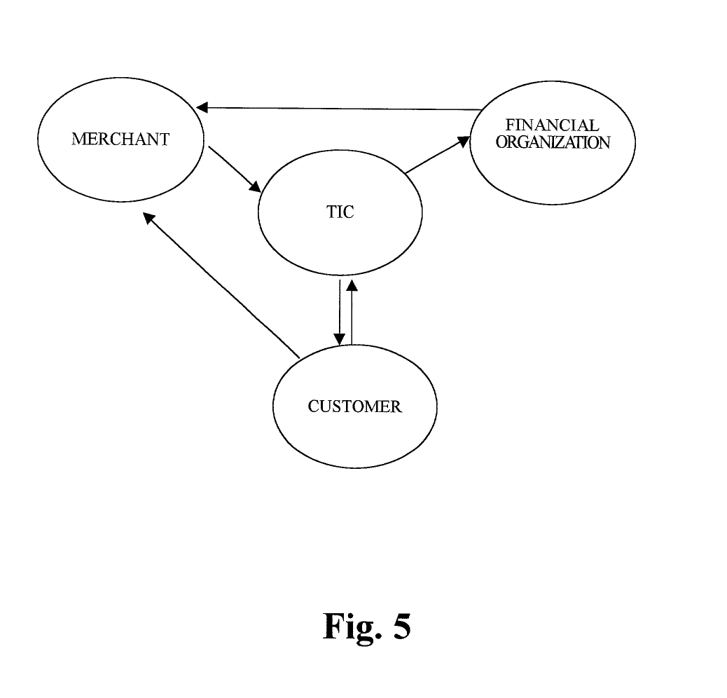

With reference to FIGS. 4 and 5, it is noted that the transaction identification center is the core of the entire transaction process. No matter the invoicing request presented by the merchant or the payment request presented by the customer, the transaction identification center will confirm the authenticity of these different requests. Furthermore, during the transaction process, the customer will need to input a transaction code, wherein the input transaction code should be the same as that originally issued to the customer. Thereafter, the transaction identification center will confirm whether the transaction code is real by means of voice mail system or through the INTERNET. Accordingly, the deceptive conduct either by the customer or the merchant will not happen throughout the entire transaction process.

It is concluded that the present invention has the follow advantages:

1. Safety;

Because the SIM card in the mobile phone has high reliability and security, hacking into the communication network will hardly happen. Besides, the invention uses two different sets of codes to identify the identity of the customer, such that the customer's right is secured.

In order to complete the transaction, the customer has to input a customer code and a transaction code to show consent to this transaction. The merchant will have no chance to have the access to both codes, so that the customer will not worry his codes will be copied.

The merchant bears no burden to receive a forged credit card or even a forged signature during the entire transaction.

2. Transaction Benefit

The customer can use this payment mechanism to pay his/her bills and every payment made by the customer will be confirmed by the transaction identification center and recorded in the financial organization, so that by the end of the month, each of the transaction will by listed out to the customer for confirmation. Therefore, even when the customer shops through the INTERNET, the customer's right is secured.

The merchant only needs a telephone to join in the payment mechanism or the merchant may use a mobile phone or even a computer capable of connecting with the INTERNET to show the easy and cost effective advantage of the method. Furthermore, should the process fee charged by the transaction identification center is less than that of the bank for the credit card, the merchant can still profit through the transaction.

The transaction identification center provides an advanced, safe and convenient payment mechanism for both the customers and the merchants. Besides, because the payment mechanism of the invention uses a lot of the mobile communication devices, a sale to the mobile communication devices is increased.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A payment method in transaction to build up a payment mechanism among a customer, a merchant, a transaction identification center and a financial organization by means of a mobile communication device, the method comprising the steps of:
customer providing a customer code issued by the transaction identification center to the merchant for undergoing a transaction by the mobile communication device;
merchant presenting an invoicing request to the transaction identification center by means of the mobile communication device and inputting a merchant code issued by the transaction identification center, the customer code and consumed money to the transaction identification center;
transaction identification center presenting a payment request to the customer with the merchant name and the consumed money for consent;
the customer inputting the transaction code to show the consent of this transaction or pressing a predetermined button for cancellation; and
the transaction identification center confirming the input transaction code and generating an authorization code to the merchant to show the recognition of this transaction.

2. The method as claimed in claim 1, wherein the mobile communication device for the customer is a mobile phone and the communication between the transaction identification center and the customer is performed by a voice mail system.

3. The method as claimed in claim 1, wherein the mobile communication device for the customer is a personal digital assistance.

4. The method as claimed in claim 1, wherein the mobile communication device for the merchant is a telephone.

5. The method as claimed in claim 1, wherein the mobile communication device for the merchant is a mobile phone.

6. The method as claimed in claim 1, wherein the mobile communication device for the merchant is a computer capable of connecting with the internet.

7. The method as claimed in claim 1, wherein the merchant is a real merchant.

8. A payment method in transaction to build up a payment mechanism among a customer, a merchant and an transaction identification center by means of a mobile communication device, the method comprising the steps of:
customer providing a customer code issued by the transaction identification center to the merchant for undergoing a transaction by the mobile communication device;
merchant presenting an invoicing request to the transaction identification center by means of the mobile communication device and inputting a merchant code issued by the transaction identification center, the customer code and consumed money to the transaction identification center;
transaction identification center presenting a payment request to the customer with the merchant name and the consumed money for consent;
the customer inputting the transaction code to show the consent of this transaction or pressing a predetermined button for cancellation;
the transaction identification center confirming the input transaction code and generating an authorization code to the merchant to show the recognition of this transaction; and
recording the transaction information in a financial organization for sending this information regularly to the customer.

9. The method as claimed in claim 8, wherein the mobile communication device for the customer is a mobile phone and the communication between the transaction identification center and the customer is performed by a voice mail system.

10. The method as claimed in claim 8, wherein the mobile communication device for the customer is a personal digital assistance.

11. The method as claimed in claim 8, wherein the mobile communication device for the merchant is a telephone.

12. The method as claimed in claim 8, wherein the mobile communication device for the merchant is a mobile phone.

13. The method as claimed in claim 8, wherein the mobile communication device for the merchant is a computer capable of connecting with the INTERNET.

14. The method as claimed in claim 4, wherein the merchant is a real merchant.
